(19) United States
(12) Patent Application Publication
(10) Pub. No.: US 2021/0018621 A1
(43) Pub. Date: Jan. 21, 2021

(54) ULTRASONIC SENSOR SYSTEM AND METHOD FOR DETECTING OBJECTS IN THE ENVIRONMENT OF A VEHICLE, AND VEHICLE HAVING AN ULTRASONIC SENSOR SYSTEM

(71) Applicant: Robert Bosch GmbH, Stuttgart (DE)

(72) Inventors: Burkhard Iske, Renningen (DE); Michael Schumann, Stuttgart (DE); Peter Preissler, Dorndorf (DE); Sebastian Olbrich, Leonberg (DE)

(21) Appl. No.: 17/040,675

(22) PCT Filed: May 3, 2019
(86) PCT No.: PCT/EP2019/061360

§ 371 Date: Sep. 23, 2020

(30) Foreign Application Priority Data
May 9, 2018 (DE) 10 2018 207 274.4

(51) Int. Cl. G01S 15/931; G01S 7/521; B60R 19/48

(52) U.S. Cl. CPC G01S 15/931; G01S 2015/938; B60R 19/483; G01S 7/521

(57) ABSTRACT

An ultrasonic sensor system for detecting objects in the environment of a vehicle is provided, which has a first group of ultrasonic sensors and a second group of ultrasonic sensors. The ultrasonic sensors of the first group each have a first installation height on the vehicle, the ultrasonic sensors of the second group of ultrasonic sensors each have a second installation height on the vehicle, the first installation height being greater than the second installation height. The ultrasonic sensors of the first group have a greater sensitivity for the detection of objects than the ultrasonic sensors of the second group.

### FIELD

The present invention relates to an ultrasonic sensor system and to a method for detecting objects in the environment of a vehicle.

### BACKGROUND INFORMATION

Methods and systems for detecting objects, in particular obstacles, are used in motor vehicles in order to assist a driver during maneuvering, for instance. More specifically, the driver is acoustically or optically alerted when the obstacles are approached. Distance sensors such as ultrasonic sensors are used for detecting an approach of the obstacles. With the aid of ultrasound, ultrasonic sensors are able to detect the presence of objects or obstacles within a limited sensing or detection range and also to measure the distance to the objects. One method for a distance measurement as a function of the vehicle data is described in German Patent No. DE 196 45 339 A1. In addition, German Patent No. DE 102 61 018 A1 describes a distance measuring device.

When detecting objects, for example, the principle of the pulse echo method is employed. The transmission and detection range of the individual ultrasonic sensor is defined by its directivity. The directivity has a vertical opening angle, which normally depends on the sensor geometry and the actuation of the ultrasonic sensor, e.g., the transmission frequency. In addition, an ultrasonic sensor is able to be installed on a vehicle in such a way that its directivity has a certain angle of inclination relative to the horizontal plane (vertical angle of inclination). It may be positive, i.e., upwardly directed, or negative, i.e., downwardly directed in the direction of the road.

The sensitivity of ultrasonic sensor systems is thus affected by the installation on the vehicle. Essential in this case is the height of the applied threshold for the detection of reflected signals because this height is normally adjusted so that ground reflection is suppressed. This applies both to fixedly set and adaptive thresholds. This requirement alone would lead to a sensor design featuring a very small opening angle or to large angles of inclination of the outer sensor surface or the directivity in the upward direction. However, another requirement in the case of ultrasonic sensor systems is the ability to detect low objects that may potentially damage the vehicle such as high curbstones. Ultrasonic sensors must therefore be installed in such a way that a significant portion of the sound emissions, i.e., the directivity, is also directed toward the ground. In order to satisfy both requirements, a compromise is usually realized in the related art. The vertical opening angle of the sound emission or the directivity amounts to approximately ±30°, for instance, and the installation of the ultrasonic sensors is to be implemented in such a way that low installation heights of, for instance, less than 50 cm with upwardly directed angles of inclination, that is to say, positive angles of inclination, and relatively high installation heights of, for instance, more than 50 cm with angles of inclination directed toward the ground, i.e., negative angles of inclination, are used. A resulting installation guideline is shown in FIG. 1.

In addition, a method is described in German Patent Application No. DE 10 2009 046 338 A1 in which a transmit signal is sent by a plurality of ultrasonic sensors, a receive signal generated by a reflection of the transmit signal at an object is received by at least one further ultrasonic sensor, and the respective receive signal is evaluated as a function of a provided sensitivity characteristic curve for the reception. The sensitivity characteristic curve is provided as a function of at least one property of the transmitting ultrasonic sensor. In this context it is shown to provide ultrasonic sensors in the region of a bumper, which are installed on top of one another for the detection of obstacles, the different ultrasonic sensors being able to have different angles of inclination and geometries in each case.

German Patent Application No. DE 10 2014 202 497 B4 describes use of a plurality of ultrasonic sensors that are situated at different height levels in the context of ultrasonic sensors installed on a longitudinal vehicle side. This makes it possible to estimate geometrical parameters of an object located on the side of a motor vehicle.

It is an object of the present invention to provide an ultrasonic sensor system having a better detection power (sensitivity) and a better detection reliability so that low-reflective objects, for instance, such as pedestrians, are able to be detected in a more reliable manner.

### SUMMARY

In accordance with an example embodiment of the present invention, ultrasonic sensors situated in the region of a bumper are positioned at at least two different height levels so that obstacles located at different distances from the vehicle or obstacles having different heights, for example, are able to be detected in a particularly satisfactory and reliable manner.

An ultrasonic sensor system for detecting objects in the environment of a vehicle is provided, which has a first group of ultrasonic sensors and a second group of ultrasonic sensors. The ultrasonic sensors of the first group have a first installation height on the vehicle, and the ultrasonic sensors of the second group of ultrasonic sensors have a second installation height on the vehicle in each case, the first installation height being greater than the second installation height. The ultrasonic sensors of the first group have a greater sensitivity for the detection of objects than the ultrasonic sensors of the second group.

In accordance with an example embodiment of the present invention, additional ultrasonic sensors are used, which are installed at a level below the conventional installation level. This lower level of ultrasonic sensors (second group) has the task of detecting low objects. According to the example embodiment of the present invention, the sensitivity of ultrasonic sensors of the first group is greater than that of the ultrasonic sensors of the second group.

The increase in sensitivity of the first group (upper sensor row) can be achieved either by installing the ultrasonic sensors using vertical angles of inclination and/or installation heights that are considerably above the installation guideline.

In one preferred embodiment, the respective directivities of the ultrasonic sensors of the first group have a positive vertical angle of inclination of in particular between 0° to 15° relative to the horizontal plane, and thus are upwardly tilted. Because of this orientation, the sensors of the first group acquire fewer ground echoes so that the threshold for the acquisition of the echo signals no longer has to be adapted to the suppression of ground echoes. As a result, a (fixed or adaptive) threshold may be used for the detection of echo signals, which makes it possible to also detect low-reflective objects such as pedestrians. The sensitivity of the ultrasonic sensors with regard to the detection of objects is thus greater. The respective directivities of the ultrasonic sensors of the second group are preferably horizontally aligned or have a negative vertical angle of inclination relative to the horizontal plane.

Both groups of ultrasonic sensors may be installed in a bumper of a vehicle, for instance. The different vertical angles of inclination of the two groups of ultrasonic sensors are preferably achieved through the respective placement of the ultrasonic sensors on a vehicle component, in particular a bumper. This means that structurally identical sensor modules are basically able to be used whose angle of inclination is adjustable by the positioning on the vehicle, e.g., via corresponding add-on parts or fasteners.

Alternatively or additionally, ultrasonic sensors having smaller vertical opening angles in comparison with the ultrasonic sensors of the second groups are able to be used in the first group. The smaller vertical opening angle also causes fewer ground echoes to be received by the ultrasonic sensors of the first group, thereby making it possible to use a threshold for the detection that also allows for the detection of low-reflective objects or objects that are located at a greater distance.

A smaller vertical opening angle is able to be realized in different ways within the framework of the present invention.

The ultrasonic sensors are preferably developed in such a way that they have a diaphragm cup having a diaphragm which is able to oscillate, and a wall surrounding the diaphragm in the conventional manner, a piezoelectric transducer being disposed on an inner side of the diaphragm. The ultrasonic sensors of the first group may now have a smaller diaphragm diameter than the ultrasonic sensors of the second group, which results in a smaller vertical opening angle of the directivity of the ultrasonic sensors of the first group.

Alternatively or additionally, the ultrasonic sensors of the first group may have a greater diaphragm stiffness. This leads to a relatively greater resonant frequency of the diaphragm cup. A higher resonant frequency results in a vertical opening angle of the directivity that is smaller in comparison and thus leads to greater sensitivity.

Preferably, the ultrasonic sensors of the first group are operated at a higher transmission frequency than the ultrasonic sensors of the second group. A higher transmission frequency results in comparison with a smaller vertical opening angle of the directivity. When using different transmission frequencies for the two groups, the same sensor design and the same sensor geometry, in particular the same diaphragm diameter for the respective ultrasonic sensors of the two groups, may be used for the respective ultrasonic sensors of the two groups. The transmission frequency for the first group should preferably be increased only to such an extent that the ultrasonic sensors of the second group still have sufficient sensitivity in this frequency range, preferably >50% in relation to the sensitivity of the ultrasonic sensors of the first group.

A variation of the vertical opening angle may also be achieved by installing an ultrasonic sensor having a funnel-shaped holder, the effective directivity achieved with regard to the object detection being affected by the geometry of the funnel. Given such an installation, the diaphragm of the ultrasonic sensor does not terminate flush with the surface, e.g., of a bumper, but is recessed from it so that the sound has to travel through the funnel situated in front.

The respective number of ultrasonic sensors of the first group and the second group is initially not restricted and also need not match.

In one preferred embodiment of an ultrasonic sensor system according to the present invention, the second group has at least as many ultrasonic sensors as the first group, and an ultrasonic sensor of the second group is situated perpendicular below each ultrasonic sensor of the first group. Especially preferably, the number of ultrasonic sensors of the first group and the second group match. This placement not only allows for the detection of an object and for determining its distance in a particularly advantageous manner, but also allows the height of the reflex with respect to the ground to be inferred, and thus the height of the detected object, through a simple trilateration in the vertical. It is furthermore preferred if the ultrasonic sensors of the first group and the ultrasonic sensors of the second group have the largest possible vertical distance from one another, or in other words, if the first installation height has the largest possible difference to the second installation height, because a height determination of the detected object is achievable in a more optimal manner in this way through a trilateration.

In one alternative embodiment of the present invention, the second group has at least one ultrasonic sensor more than the first group, and an ultrasonic sensor of the first group is situated at an offset between two adjacent ultrasonic sensors of the second group in each case. Such a placement of the ultrasonic sensors in the upper row (second group) between the ultrasonic sensors in the lower row (first group) makes it possible to cover the region of the bumper of the vehicle in the horizontal in a more optimal manner because the horizontal clearance between two sensors is reduced. In locations where a large distance is required between adjacent sensors of the same group (such as at the license plate holder), for instance, it is possible to reduce the horizontal distance between a sensor of the first group and the next sensor of the second group. Even in such a position, a height determination may continue to be realized by a trilateration, in particular a 3D trilateration.

As a whole, it may be advantageous to provide more ultrasonic sensors in the second group (lower row) than in the first group because especially with an installation in the bumper, the most complete space around the bumper and toward the ground is then able to be covered in terms of sensing, in particular since the ultrasonic sensors of the second group are less sensitive than the ultrasonic sensors of the first group.

In one preferred embodiment of the present invention, certain, or also all, ultrasonic sensors, but especially the ultrasonic sensors of the first group, may be positioned and aligned in such a way or may have an angle of inclination such that objects above the vehicle, e.g., the ceiling of a parking facility or a through passage, are able to be detected as well. For example, it can thereby be detected whether a through passage is high enough for a vehicle.

According to a further aspect of the present invention, a vehicle having at least one ultrasonic sensor system embodied according to the present invention is provided for the detection of objects in the environment of the vehicle, the ultrasonic sensors of the ultrasonic sensor system being placed on a front bumper and/or a rear bumper of the vehicle or on the side of the vehicle such as within the B column.

The first installation height on the vehicle of the ultrasonic sensors of the first group preferably has a value in a range of 50 cm to 80 cm. The second installation height preferably has a value in the range of 20 cm to 40 cm.

According to one further aspect of the present invention, an example method is provided for detecting objects in the environment of a vehicle with the aid of an ultrasonic sensor system according to the present invention, in which objects whose distance from the ultrasonic sensors of the first group is greater than a limit distance are detected with the aid of the ultrasonic sensors of the first group, and objects whose distance from the ultrasonic sensors of the second group is smaller than the limit distance are detected with the aid of the ultrasonic sensors of the second group. The limit distance may amount to 40 cm, for instance.

The present invention provides different advantages. The ultrasonic sensor system according to the present invention has greater sensitivity for high objects. In addition, better coverage of the vertical field of view of the overall system results in comparison with the related art. If the ultrasonic sensors are installed at only one level or one installation height, as is the case in many conventional systems, blind spots result on account of the restricted opening angle in the vertical, both above and below the installation height. Small children, for example, whose body size may lie in this blind spot region below the installation height may possibly not be detected when they are too close to the vehicle. This risk is able to be reduced with the aid of the ultrasonic sensor system developed according to the present invention. Moreover, due to the use of ultrasonic sensors having vertically overlapping directivities or fields of view, sensor defects are able to be detected more easily by plausibilizing echo signals with the aid of a further ultrasonic sensor, which has an overlapping field of view. In addition, an arithmetic reduction of the total error rate of the system with regard to the functional safety classification is able to be achieved by the redundancy (e.g., surface cover detection/accident damage, damage due to falling rocks). There is furthermore the possibility of operating the system as what is known as a fail-operational system. A characteristic of a fail-operational system is that the application function is able to be maintained in the event of a defect of a maximum number of sensors. A faster initial detection of objects is possible as a whole because of the higher number of echo confirmations. In addition, an ultrasonic sensor system developed according to the present invention allows for a height measurement of the detected objects through a vertical trilateration.

### BRIEF DESCRIPTION OF THE DRAWINGS

FIG. 1 shows a diagram of the installation heights in relation to the vertical angle of inclination of an ultrasonic sensor.

FIG. 2a) schematically illustrates a front view of a vehicle having an ultrasonic sensor system for detecting objects in the environment of the vehicle according to a first exemplary embodiment of the present invention.

FIG. 2b) schematically illustrates an ultrasonic sensor of the first group and an ultrasonic sensor of the second group of the ultrasonic sensor system, in accordance with an example embodiment of the present invention.

FIG. 3a) schematically illustrates a side view of a vehicle having an ultrasonic sensor system for detecting objects in the environment of the vehicle according to the related art.

FIG. 3b) schematically illustrates a side view of a vehicle having an ultrasonic sensor system for detecting objects in the environment of the vehicle according to a second exemplary embodiment of the present invention.

FIG. 4 schematically shows a front view a vehicle having an ultrasonic sensor system for detecting objects in the environment of the vehicle according to a third exemplary embodiment of the present invention.

### DETAILED DESCRIPTION OF EXAMPLE EMBODIMENTS

In the description below of the exemplary embodiments of the present invention, identical elements are denoted by matching reference numerals and a repeated description of these elements is omitted as the case may be. The figures represent the object of the present invention merely schematically.

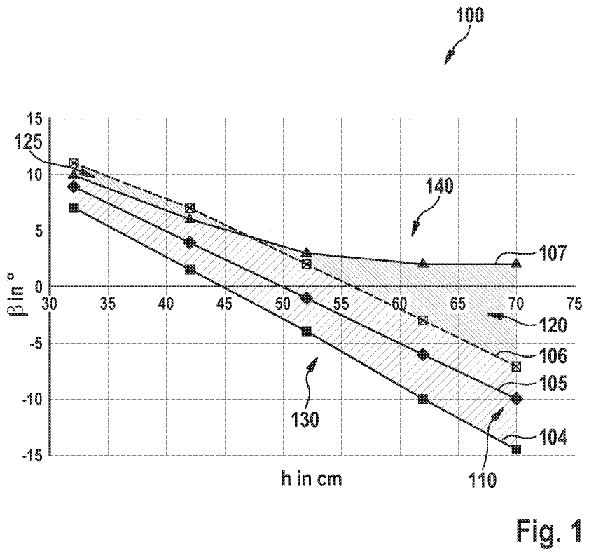

FIG. 1 shows a diagram 100 in which installation height h of an exemplary ultrasonic sensor of an ultrasonic sensor system for detecting objects in the environment of a vehicle has been plotted in cm on the x-axis versus the vertical angle of inclination β of the ultrasonic sensor. The illustrated value ranges are defined by the design of the ultrasonic sensor and should therefore be understood merely as examples.

The range of combinations of installation height h and angle of inclination β 110, which is restricted in the downward direction by curve 104, restricted for installation heights of more than approximately 46 cm in the upward direction by curve 106, and restricted for installation heights of less than 46 cm by curve 107, constitutes the range of combinations of h and β that the ultrasonic sensors of typical ultrasonic sensor systems possess for detecting objects in the environment of a vehicle in order to satisfy both the requirements of the sensitivity and the requirement of still being able to detect low objects. Curve 105 represents the best compromise and was thus recommended in conventional ultrasonic sensor systems as what is known as an installation guideline. Curve 106 represents combinations of installation height and vertical angle of inclination at which echo signals from the ground are just barely still able to be detected (“upper limit ground”). Curve 104 represents combinations of installation height and angle of inclination at which the sensitivity is just barely still sufficient (“low limit”). Curve 107 represents combinations of installation height and angle of inclination at which barely any interfering echo signal will be received from a ceiling, e.g., of a garage or a parking facility (“upper limit ceiling”). Range 120 in systems according to the related art may possibly be tolerated if an application is involved in which the detection of low objects such as curbstones plays only a minor role. For example, low objects such as curbstones in the case of vehicles having a high chassis clearance (such as pickup trucks) are not very important. In smaller vehicles having a low chassis clearance and a small wheelbase (e.g., sports cars or city “Flitzer” cars), on the other hand, low objects are of a greater relevance. For instance, range 125 in systems according to the related art is permitted on the condition that the total range of the ultrasonic sensors is limited, such as to 150 cm, because there would otherwise be the risk that an interfering echo signal will be received from a ceiling such as in a garage or in a parking facility. Range 140 above curves 106 and 107 in systems according to the related art is not permitted, for instance because of the risk that an interfering echo from a ceiling, e.g., in a garage or in a parking facility, will be received and simultaneously no echo signals are received from the ground or from very low objects. For instance, range 130 below curve 104 is not allowed in systems according to the related art because the sensitivity is too low on account of the high portion of received ground echoes.

The present invention now makes it possible to place ultrasonic sensors even in the “forbidden” regions or to modify the form of the regions. For example, the ultrasonic sensors of the second group in an ultrasonic sensor system developed according to the present invention for the detection of objects in the environment of a vehicle may also be developed using combinations of installation height and vertical angle of inclination in range 130. The ultrasonic sensors of the first group of the ultrasonic sensor system developed according to the present invention may have combinations of installation height and vertical angle of inclination in ranges 110, 120 and 125, and these ranges may be enlarged, for instance in that the ultrasonic sensors of the first group have a smaller opening angle in their directivity.

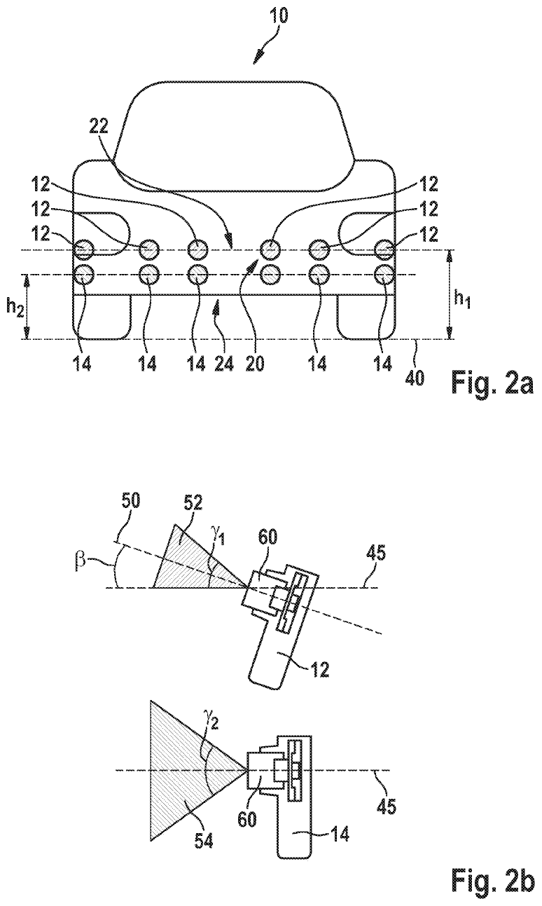

FIG. 2a) schematically shows a front view of a vehicle 10 having an ultrasonic sensor system 20 for detecting objects in the environment of vehicle 10 according to a first exemplary embodiment of the present invention. Ultrasonic sensor system 20 includes twelve ultrasonic sensors 12, 14, of which six ultrasonic sensors 12 belong to a first group 22 of ultrasonic sensors, and six ultrasonic sensors 14 belong to a second group 24. Ultrasonic sensors 12 of first group 22 have a first installation height h₁ on the vehicle relative to a road surface 40. Ultrasonic sensors 14 of second group 24 have a second installation height h₂ on the vehicle relative to road surface 40, first installation height h₁ being greater than second installation height h₂. According to the present invention, ultrasonic sensors 12 of first group 22 have a greater sensitivity for the detection of objects than ultrasonic sensors 14 of second group 24.

In this example, the number of ultrasonic sensors 12 of first group 22 corresponds to the number of ultrasonic sensors 14 of second group 24. Situated perpendicularly above each ultrasonic sensor 14 of second group 24 is an ultrasonic sensor 12 of first group 22. This placement makes it possible to infer the height of an acquired echo signal in relation to road surface 40 via a simple trilateration in the vertical, and thus to infer the height of a detected object.

FIG. 2b) schematically shows an ultrasonic sensor 12 of first group 22 and an ultrasonic sensor 14 of second group 24 of ultrasonic sensor system 20 from FIG. 2a). In this particular example, ultrasonic sensor 12 has a positive vertical angle of inclination β. Directivity 52 or main axis 50 of the directivity is upwardly inclined relative to horizontal 45. Ultrasonic sensor 14 has a directivity 54 that is not inclined relative to horizontal 45. Opening angle γ₁ of directivity 52 of ultrasonic sensor 12 is smaller than opening angle γ₂ of directivity 54 of ultrasonic sensor 14.

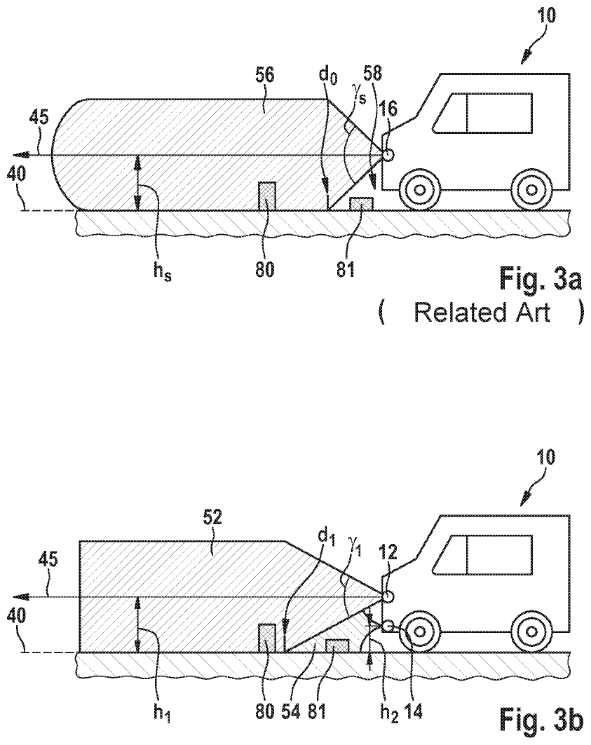

FIG. 3a) schematically shows a side view of a vehicle 10 having a conventional ultrasonic sensor system for detecting an object 80 according to the related art. The ultrasonic sensor system has at least one ultrasonic sensor 16, which is installed at a certain installation height hₛ relative to road surface 40. Installation height hₛ amounts to 50 cm, for example. Shown is directivity 56 or the vertical field of view of ultrasonic sensor 16. It has an opening angle γₛ and furthermore has no inclination of the main axis relative to horizontal 45 in this particular example. It can be seen that the field of view intersects with road surface 40 at a distance d₀. Low objects that are located closer to this limit distance d₀ from the vehicle, i.e., roughly in gap region 58, may possibly not be detected at all by ultrasonic sensor 16 or only in a very unreliable fashion. This may lead to a risk to the vehicle or also to the object.

FIG. 3b) schematically shows a side view of vehicle 10 having an ultrasonic sensor system 20 for detecting an object 80 according to a second exemplary embodiment of the present invention. Ultrasonic sensor system 20 has two groups 22, 24 of ultrasonic sensors 12, 14, each being mounted at a certain first and second installation height h₁ and h₂, respectively, relative to road surface 40. Installation height h₁ amounts to 50 cm, for example. Shown is directivity 52 or the vertical field of view of an ultrasonic sensor 12 of first group 22 having installation height h₁. In this example it has no inclination of the main axis with respect to horizontal 45, but opening angle γ₁ of directivity 52 is smaller in comparison with opening angle γₛ according to the related art of FIG. 2a). This has the result that the field of view intersects with road surface 40 at a distance d₁, d₁ being greater than d₀. This has the effect that fewer ground echoes are received by ultrasonic sensor 12, or that ground echoes having a lower intensity are received so that the detection threshold of ultrasonic sensor 12 is able to be selected to have a corresponding greater sensitivity. Ultrasonic sensor 12 thus has a greater sensitivity, in particular for high objects, than ultrasonic sensor 16 of the related art. However, low objects 80 that are located closer to vehicle 10 than limit distance d₁ are not detected by ultrasonic sensor 12 or only very unreliably. According to the present invention, this detection gap is closed by utilizing second group 24 of ultrasonic sensors 14. Ultrasonic sensor 14 has a field of view or a directivity 54 that essentially covers the region of close and low objects 81 and consequently allows for a reliable detection of such objects 81.

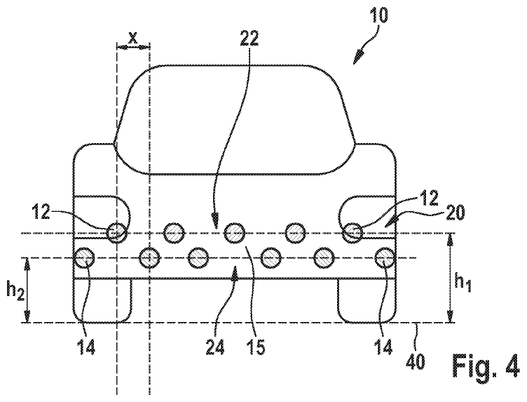

FIG. 4 schematically shows a front view of a vehicle 10 including an ultrasonic sensor system 20 for detecting objects in the environment of sensor 10 according to a third exemplary embodiment of the present invention. In this case, ultrasonic sensor system 20 includes eleven ultrasonic sensors 12, 14, of which five ultrasonic sensors 12 belong to a first group 22 of ultrasonic sensors and six ultrasonic sensors 14 belong to a second group 24. Ultrasonic sensors 12 of first group 22 have a first installation height h₁ on the vehicle relative to a road surface 40. Ultrasonic sensors 14 of second group 24 have a second installation height h₂ on the vehicle relative to road surface 40, first installation height h₁ being greater than second installation height h₂. According to the present invention, ultrasonic sensors 12 of first group 22 have a greater sensitivity for the detection of objects than ultrasonic sensors 14 of second group 24.

In this example, the number of ultrasonic sensors 14 of second group 24 corresponds to the number of ultrasonic sensors 12 of first group 22 plus one. An ultrasonic sensor 12 of first group 22 is situated at an offset between two adjacent ultrasonic sensors 14 of second group 24. Because of such a placement of ultrasonic sensors 12 in the upper row (second group 22) between ultrasonic sensors 14 in the lower row (first group 24), the region of the bumper of the vehicle in the horizontal is advantageously able to be covered in a more optimal manner because horizontal distance x between two adjacent ultrasonic sensors 12, 14 is reduced, e.g., in comparison with a placement according to FIG. 2a). For example, in locations 15, where a large distance is required between adjacent ultrasonic sensors of second group 24 (e.g., at the number plate holder), horizontal distance x between a sensor 12 of the first group and next sensor 14 of the second group is able to be reduced. This results in a sufficient sensor coverage to ensure the reliable detection of low objects also in region 15 of the number plate.

1-15. (canceled)

16. An ultrasonic sensor system for detecting objects in an environment of a vehicle, comprising:
a first group of ultrasonic sensors each having a first installation height on the vehicle; and
a second group of ultrasonic sensors each having a second installation height on the vehicle, the first installation height being greater than the second installation height;
wherein the ultrasonic sensors of the first group have a greater sensitivity for detection of objects than the ultrasonic sensors of the second group.

17. The ultrasonic sensor system as recited in claim 16, wherein respective directivities of the ultrasonic sensors of the first group have a positive vertical angle of inclination relative to a horizontal plane in a range of +0° to +15°.

18. The ultrasonic sensor system as recited in claim 16, wherein respective directivities of the ultrasonic sensors of the second group are: (i) horizontally aligned, or (ii) have a negative vertical angle of inclination relative to a horizontal plane.

19. The ultrasonic sensor system as recited in claim 16, wherein respective directivities of the ultrasonic sensors of the first group have a smaller vertical opening angle than respective directivities of the ultrasonic sensors of the second group.

20. The ultrasonic sensor system as recited in claim 16, wherein the second group has at least as many ultrasonic sensors as the first group, a respective ultrasonic sensor of the second group being situated perpendicularly below each ultrasonic sensor of the first group.

21. The ultrasonic sensor system as recited in claim 16, wherein the second group has at least one ultrasonic sensor more than the first group, and a respective ultrasonic sensor of the first group being situated at an offset between two adjacent ultrasonic sensors of the second group, in each case.

22. The ultrasonic sensor system as recited in claim 16, wherein the ultrasonic sensors of the first group and the ultrasonic sensors of the second group have an identical design and different vertical angles of inclinations, the different vertical angles of inclination being due to a respective installation of the ultrasonic sensors of the first and second groups on a vehicle component.

23. The ultrasonic sensor system as recited in claim 22, wherein the vehicle component is a bumper.

24. The ultrasonic sensor system as recited in claim 16, wherein each of the ultrasonic sensors of the first and second groups include a diaphragm cup having a diaphragm able to oscillate and a wall surrounding the diaphragm, a piezoelectric transducer being disposed on an inner side of the diaphragm, the ultrasonic sensors of the first group having a smaller diaphragm diameter and/or a greater diaphragm stiffness than the ultrasonic sensors of the second group.

25. The ultrasonic sensor system as recited in claim 16, wherein each of the ultrasonic sensors of the first group and/or each of the ultrasonic sensors of the second group, has a funnel-shaped holder, a directivity of the ultrasonic sensors of the first group and/or a directivity of the ultrasonic sensors of the second group being influenced by the funnel-shaped holder.

26. The ultrasonic sensor system as recited in claim 16, wherein the ultrasonic sensors of the first group are operated at a higher transmission frequency than the ultrasonic sensors of the second group.

27. The ultrasonic sensor system as recited in claim 16, wherein the ultrasonic sensors of the first group are situated and aligned in such a way or have an angle of inclination such that objects above the vehicle are able to be detected using the ultrasonic sensors of the first group.

28. A vehicle, comprising:
at least one ultrasonic sensor system for detecting objects in an environment of the vehicle, the at least one ultrasonic sensor system including:
a first group of ultrasonic sensors each having a first installation height on the vehicle, and
a second group of ultrasonic sensors each having a second installation height on the vehicle, the first installation height being greater than the second installation height,
wherein the ultrasonic sensors of the first group have a greater sensitivity for detection of objects than the ultrasonic sensors of the second group;
wherein the ultrasonic sensors of the first group and the second group are positioned on a front and/or a rear bumper of the vehicle.

29. The vehicle as recited in claim 28, wherein the first installation height has a value in a range of 50 cm to 80 cm, and the second installation height has a value in a range of 20 cm to 40 cm.

30. A method for detecting objects in an environment of a vehicle, the vehicle including at least one ultrasonic sensor system for detecting the objections, the at least one ultrasonic sensor system including a first group of ultrasonic sensors each having a first installation height on the vehicle, and a second group of ultrasonic sensors each having a second installation height on the vehicle, the first installation height being greater than the second installation height, wherein the ultrasonic sensors of the first group have a greater sensitivity for detection of objects than the ultrasonic sensors of the second group, wherein the ultrasonic sensors of the first group and the second group are positioned on a front and/or a rear bumper of the vehicle, the method comprising:
detecting objects whose distance from the ultrasonic sensors of the first group is greater than a limit distance using the ultrasonic sensors of the first group; and
detecting objects whose distance from the ultrasonic sensors of the second group is smaller than the limit distance using the ultrasonic sensors of the second group.

31. The method as recited in claim 30, wherein the limit distance is 40 cm.
